(19) United States
(12) Patent Application Publication
(10) Pub. No.: US 2024/0188519 A1
(43) Pub. Date: Jun. 13, 2024

(54) AQUACULTURE DEVICE

(71) Applicant: Richard P. Milliard, Saco, ME (US)

(72) Inventor: Richard P. Milliard, Saco, ME (US)

(21) Appl. No.: 18/062,679

(22) Filed: Dec. 7, 2022

(51) Int. Cl. A01G 33/00

(52) U.S. Cl. CPC A01G 33/00

(57) ABSTRACT

An aquaculture device for growing kelp in the ocean is provided. The device includes an upper hub having an outer rim, where the outer rim of the upper hub has a first perimeter, and the device includes a lower hub having an outer rim, where the outer rim of the lower hub has a second perimeter, where the second perimeter is larger than the first perimeter. The device further includes a plurality of connecting arms coupling the upper hub to the lower hub, and the upper hub and the lower hub are configured to hold kelp seeded grow lines in a diagonal orientation relative to the upper hub outer rim and the lower hub outer rim. The aquaculture device may further includes a floatation structure coupled to the lower hub and configured to be filled with a fluid to adjust the buoyancy of the aquaculture device. Methods of growing kelp in the ocean are also provided. The method may include attaching kelp seeded grow lines to the outer rim of the upper hub and to the outer rim of the lower hub in a diagonal orientation.

### FIELD OF THE INVENTION

This disclosure relates to a device used for growing kelp in an ocean environment.

### BACKGROUND

Kelp (i.e. sea kelp or seaweed) may be grown in a variety of ways. For example, a string may be seeded and then coupled to a grow line. The grow line is generally more robust than the seeded string and provides additional support structure for the growing kelp. More specifically, the kelp may be developed in a laboratory environment while controlling filtered seawater temperature, light, and oxygenation. In the lab, the kelp seed may settle and adhere to the string. After about six to eight weeks, the kelp may be sufficiently mature and the kelp seeded string may be removed from the laboratory and transported to the ocean. PVC tubes may be used to convey the seeded string (i.e. the seeded string may be wound around a PVC tube for transportation). The grow line may be passed through the PVC tube. Then, the kelp seeded string may be fastened to an anchor line in the ocean. A boat may slowly move away unwinding the seeded string from around the PVC tube and onto the grow line. The grow lines may be fastened together and the kelp seeded strings are fastened to the grow lines. This process continues until all of the grow lines are seeded.

The kelp seeded grow lines may be tended to periodically until harvested. The kelp may progress from being small fuzz-like seedlings on the seeded string to kelp plants four feet or more long at harvest. In the New England area, the seeded grow lines may be transported from the laboratory to the ocean in November and the kelp may be harvested from the grow lines in the ocean in late April or May. At harvest, kelp farmers in boats will lift the grow lines laden with kelp and the farmers typically use knives or other cutting tools to cut the kelp from the grow lines. The kelp may then be brought to a processing facility.

There are a variety of devices known for supporting the grow lines in the ocean. In Norway for example, kelp farmers zig-zag the grow lines across two spaced apart ropes in a horizontal orientation in the ocean. In the Faroe Islands, kelp farmers implement vertically arranged grow lines with small floats on each grow line, attaching all of the grow lines to a submerged main line.

### SUMMARY

According to one aspect of the present disclosure, an aquaculture device for growing kelp in the ocean is provided. The device includes an upper hub having an outer rim, where the outer rim of the upper hub has a first perimeter, and a lower hub having an outer rim, where the outer rim of the lower hub has a second perimeter, and where the second perimeter is larger than the first perimeter. The device further includes a plurality of connecting arms coupling the upper hub to the lower hub, where the upper hub and the lower hub are configured to hold kelp seeded grow lines in a diagonal orientation relative to the upper hub outer rim and the lower hub outer rim. The device also includes a floatation structure coupled to the lower hub, where the floatation structure is configured to be filled with a fluid to adjust the buoyancy of the aquaculture device.

According to another aspect of the present disclosure, a method of growing kelp in the ocean is provided. The method includes providing an aquaculture device, the aquaculture device including an upper hub having an outer rim, where the outer rim of the upper hub has a first perimeter, a lower hub having an outer rim, where the outer rim of the lower hub has a second perimeter, and where the second perimeter is larger than the first perimeter. The device may also include a plurality of connecting arms coupling the upper hub to the lower hub. The method also includes placing the aquaculture device in the ocean, and attaching kelp seeded grow lines to the outer rim of the upper hub and to the outer rim of the lower hub in a diagonal orientation.

### BRIEF DESCRIPTION OF THE DRAWINGS

FIG. 1 is a perspective view of an aquaculture device according to one embodiment;

FIG. 2 is a side view of an aquaculture device shown deployed in the ocean according to one embodiment;

FIG. 3 is a top view of an inner rim of the upper hub of the aquaculture device according to one embodiment;

FIG. 4 is a top view of an outer rim and inner rim of the upper hub of the aquaculture device according to one embodiment;

FIG. 5 is a top view of a portion of the upper hub shown in FIG. 4;

FIG. 6 is a top view of the lower hub of the aquaculture device according to one embodiment;

FIG. 7 is a top view of a portion of the lower hub which includes an inner rim and an intermediate rim according to one embodiment;

FIG. 8 is a side view of a portion of the aquaculture device which includes vertical connecting arms coupling the upper hub to the lower hub;

FIG. 9 is a schematic representation of seeded grow lines secured to the aquaculture device according to one embodiment;

FIG. 10 is a schematic representation of a plurality of aquaculture devices spaced apart in an array in the ocean according to one embodiment;

FIG. 11 is a schematic representation of the approximate amount of swing/movement of an aquaculture device in the ocean based upon varying ocean conditions;

FIG. 12 is a schematic representation of the length of the seeded grow lines based upon different sized aquaculture devices according to different embodiments of the present disclosure; and

FIG. 13 is a schematic representation of the floatation structure configured to adjust the buoyancy of the aquaculture device and compressor data according to one embodiment; and

FIG. 14 is a schematic representation of zig-zag seeded grow lines on the aquaculture device according to one embodiment.

### DETAILED DESCRIPTION

The present disclosure is directed to an aquaculture device for growing kelp in an ocean environment. The Applicant recognized that there were problems associated with the prior approaches to growing kelp in the ocean. First, the prior approaches relied on a single plane orientation of the kelp seeded grow lines (horizontal or vertical). The Applicant recognized that the prior designs often used this single plane orientation of kelp seeded grow lines so that the grow lines could be oriented parallel with major currents to attempt to limit stress upon the anchoring system. Furthermore, in the U.S., these prior designs were often placed in locations close to shore to limit the harsh ocean conditions.

The Applicant designed both an improved device and its methods of use for growing kelp. As set forth in more detail below, the Applicant developed a new aquaculture device which enables a kelp farmer to orient the kelp seeded grow lines in multiple planes which may increase the amount of kelp that can be harvested in a given ocean area. As set forth in more detail below, the Applicant developed a more robust device for holding seeded grow lines that may be capable of better withstanding major currents, winds and/or storms. In one embodiment, the aquaculture device is designed to be substantially symmetrical about its vertical central axis, such that the device does not require a particular orientation in the ocean to best withstand the harsh ocean environment. Because the design may be more robust, it is also not limited to locations close to shore, but rather is capable of being deployed in offshore locations in deeper ocean waters.

Finally, the Applicant recognized that certain prior devices for growing kelp in the ocean were configured so that it was difficult to raise the grow lines up to the water surface and/or out of the water for harvesting. For example, one prior approach requires a crane for harvesting the kelp. In contrast, as set forth in more detail below, Applicant developed an aquaculture device that employs a flotation structure that is configured to adjust the buoyancy of the aquaculture device to lower the device into the ocean and/or to raise it up to the water surface so that it is easier to seed, tend, maintain and/or harvest the kelp.

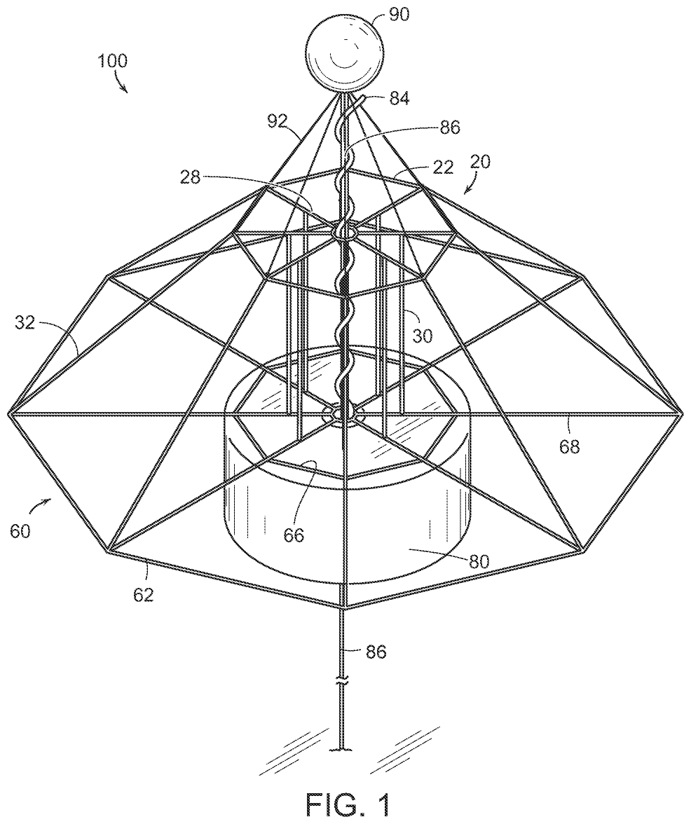

Turning now to FIGS. 1-8, one embodiment of an aquaculture device will be described. As shown in the perspective view shown in FIG. 1, in one embodiment, the aquaculture device 100 includes an upper hub 20 having an outer rim 22, and a lower hub 60 having an outer rim 62. As shown in FIG. 1, the upper hub outer rim 22 has a first perimeter and the lower hub outer hub 62 has a second perimeter, where the second perimeter is larger than the first perimeter. In other words, the lower hub outer rim 62 is bigger than the upper hub outer rim 22. In one particular embodiment, the outer rim 22 of the upper hub 20 has a first perimeter of approximately 28 feet (eight rods, each having a length of about 3.5 feet), and the outer rim 62 of the lower hub 60 has a second perimeter of approximately 72 feet (eight rods, each having a length of about 9 feet). As set forth in more detail below, because of this difference in outer hub perimeter size, the upper hub 20 and the lower hub 60 are configured to hold kelp seeded grow lines in a diagonal orientation relative to the upper hub outer rim 22 and the lower hub outer rim 62 which provides numerous benefits which are outlined below. The aquaculture device 100 also includes a plurality of connecting arms 30, 32 coupling the upper hub 20 to the lower hub 60. Further details regarding both the upper hub 20, the lower hub 60, and the connecting arms 30, 32 are discussed in more detail below.

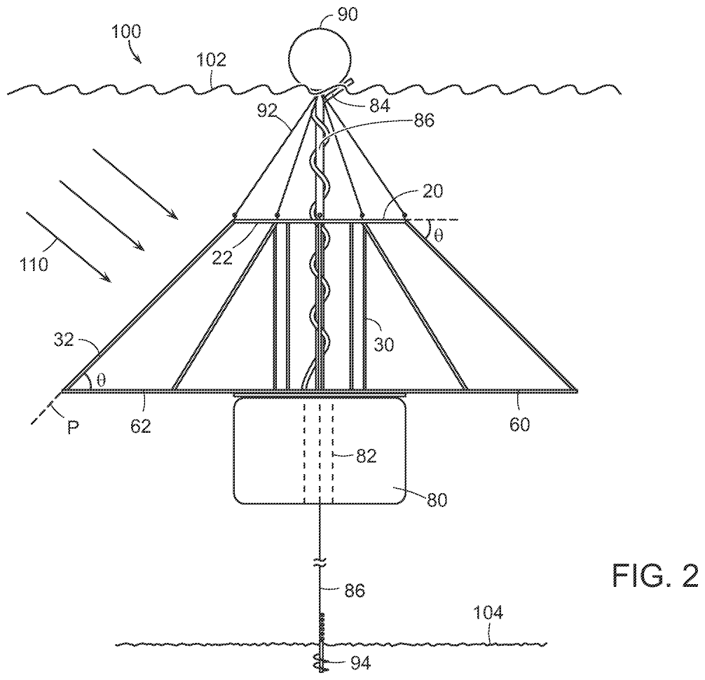

As shown in FIGS. 1-2, in one illustrative embodiment, the aquaculture device 100 includes a flotation structure 80 configured to be filled with a fluid to adjust the buoyancy of the aquaculture device 100. Various flotation structure configurations are contemplated by the present disclosure, but in one particular embodiment, the flotation structure 80 is at least partially open at the bottom so that when the aquaculture device 100 is submerged under water, the flotation structure 80 fills with ocean water. As set forth in more detail below, the floatation device 80 may be configured such that when it is desired to raise the aquaculture device 100 up to the water surface 102, the floatation structure 80 may be filled with a more buoyant fluid, such as air, to make the aquaculture device 100 more buoyant. Further details regarding the floatation structure 80 are discussed in more detail below.

FIG. 2 illustrates a side view of one embodiment of an aquaculture device 100 deployed in the ocean. As shown, the device 100 may include a mooring ball 90 coupled to the upper hub 20, and in one particular embodiment a plurality of suspension lines 92 couple the mooring ball 90 to the outer rim 22 of the upper hub 20. As also shown in FIG. 2, a mooring line 86 and anchor 94 may be coupled to the mooring ball 90. As shown in FIG. 2, the flotation structure 80 may have a central hole 82 extending therethough and the mooring line 86 may extend through the central hole 82 in the flotation structure 80. In the embodiment illustrated in FIG. 2, the mooring ball 90 is sufficiently buoyant to remain floating on the water surface 102 and the mooring line 86 is sufficiently long so that the anchor 94 may be positioned on the ocean floor 104. One of ordinary skill in the art will appreciate that the length of the mooring line 86 may be adjusted based upon the specific ocean depth.

As mentioned above, aspects of the present disclosure are directed to an aquaculture device 100 which is configured to hold the kelp seeded grow lines in a diagonal orientation relative to the upper hub outer rim 22 and the lower hub outer rim 62. Applicant recognized that this diagonal orientation may be desirable to align with the angle of the sun. As shown in FIG. 2, the device 100 is configured so that the kelp seeded grow lines are oriented along plane P which is diagonal relative to the upper hub outer rim 22 and the lower hub outer rim 62. As shown, due to the angle of the sun, the sun rays 110 are directed downwardly toward the aquaculture device 100, and in one embodiment, the device 100 may be configured so that the angle θ is substantially equal to the angle of the sun. As shown in FIG. 2, the upper hub 20 and the lower hub 60 may be configured such that the plane P which defines the orientation of the kelp seeded grow lines is substantially perpendicular to the sun rays 110, thus maximizing the sun exposure to the kelp seeded grow lines.

As set forth in more detail below, the Applicant recognized that by designing a device 100 which is configured to hold the kelp seeded grow lines in a diagonal orientation, one can maximizing the sun exposure on the kelp seeded grow lines. Applicant recognized that the angle of the sun rays 110 can vary based upon the location of the aquaculture device 100. One can appreciate that the angle of the sun rays 110 off the Atlantic coast in Maine is, for example, different than the angle of the sun rays 110 off the coast of Hawaii. As shown in FIG. 2, the angle θ may be calculated based upon the specific location that the aquaculture device 100 is intended to be deployed. In one embodiment, the upper hub 20 and the lower hub 60 are configured to hold the kelp seeded grow lines in a diagonal orientation between approximately 30° and approximately 60° relative to the upper hub outer rim 22 and the lower hub outer rim 62. In one particular embodiment, an angle θ of approximately 45° is ideal for an aquaculture device deployed off the coast of southern Maine. As discussed below, other locations may need to adjust the angle θ to latitude by either lengthening or shortening the length of the connecting arms 30, 32 for a good sun incidence angle.

As shown in FIG. 1, in one illustrative embodiment, the upper hub outer rim 22 and the lower hub outer rim 62 each have a substantially octagonal shape. Applicant recognized that an octagonal shape may provide a robust structure that is symmetrical, and thus able to withstand some of the harsh ocean conditions regardless of the direction of the winds and/or ocean currents. In one embodiment, the upper hub outer rim 22 and the lower hub outer rim 62 are each formed of eight radial arm segments which may be welded together.

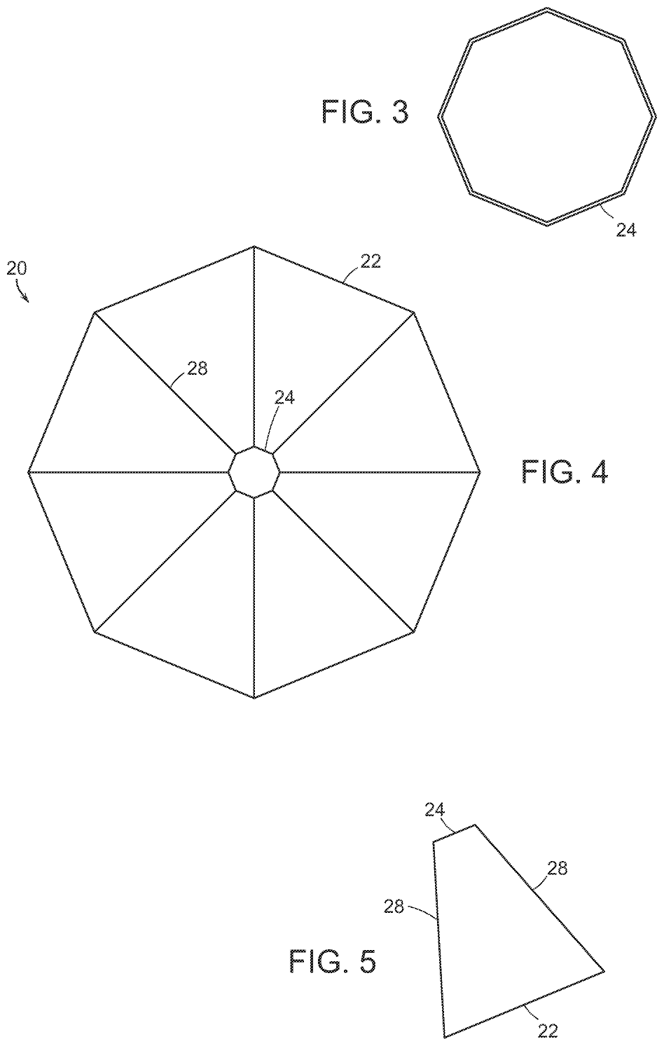

Turning now to FIGS. 3-8, further details regarding the upper hub 20 and the lower hub 60 will be discussed. In addition to having an outer rim 22, in one illustrative embodiment shown in FIGS. 3-5, the upper hub 20 also has an inner rim 24, and a plurality of spokes 28 may extend radially outwardly from the inner rim 24 to the outer rim 22 of the upper hub 20. It should be appreciated that the inner rim 24 and the plurality of spokes 28 may provide additional stability increasing the robustness of the overall aquaculture device 100.

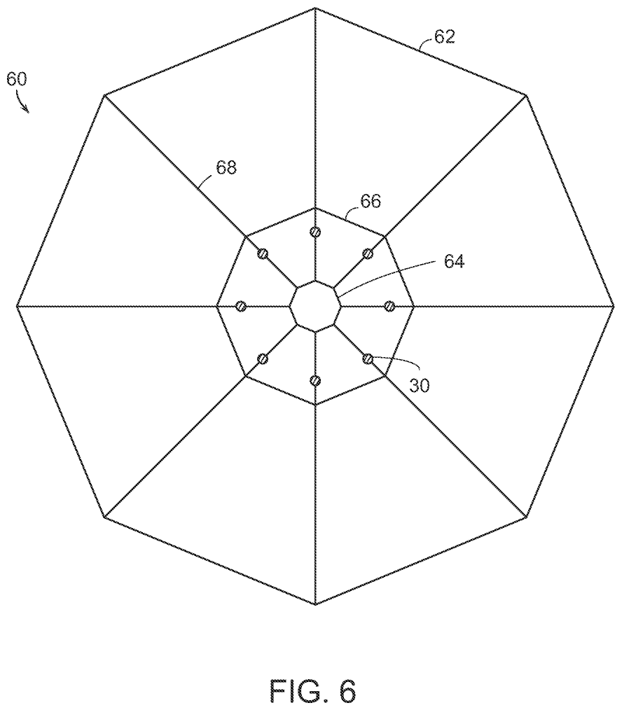

As shown in FIG. 6, in addition to having the above mentioned outer rim 62, in one illustrative embodiment, the lower hub 60 also has an inner rim 64, and a plurality of spokes 68 may extend radially outwardly from the inner rim 64 to the outer rim 62 of the lower hub 60. It should be appreciated that the inner rim 64 and the plurality of spokes 68 may provide further stability increasing the robustness of the overall aquaculture device 100.

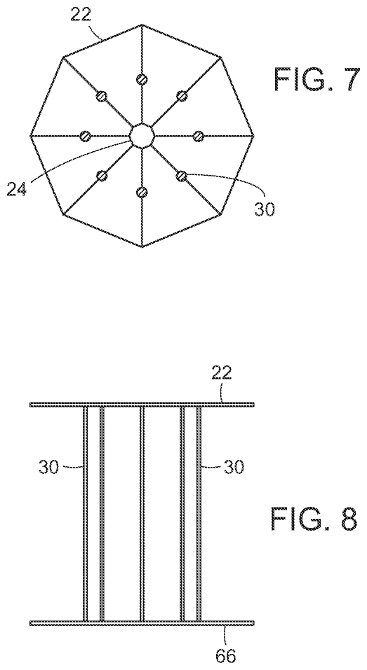

Additionally, as shown in FIG. 6, the lower hub 60 may further include an intermediate rim 66, and as shown, the plurality of spokes 68 on the lower hub 60 may pass through the intermediate rim 66. As set forth in more detail below, the intermediate rim 66 of the lower hub 60 has a third perimeter, which may be substantially equal to the first perimeter of the upper hub 20. In other words, the lower hub intermediate rim 66 is substantially the same size as the upper hub outer rim 22. This is also shown in the side view shown in FIG. 8 which illustrates the outer rim 22 of the upper hub 20 and the intermediate rim 66 of the lower rim 60. As shown in FIGS. 6-7, in one illustrative embodiment, there are a plurality of arms 30 which extend in a substantially vertical orientation between the upper hub outer rim 22 and the lower hub intermediate rim 66. As shown, the arms 30 may be coupled to the spokes 28 on the upper hub 20 and the spokes 68 on the lower hub 60. As shown in FIGS. 1-2, these substantially vertically oriented arms 30 connect the upper hub 20 to the lower hub 60 and may provide additional stability increasing the robustness of the overall aquaculture device 100.

As shown in FIGS. 1-2, in one embodiment, the aquaculture device 100 also includes a plurality of arms 32 which extend in a diagonal orientation relative to the upper hub outer rim 22 and the lower hub outer rim 62. As shown in FIG. 2, these diagonally oriented arms 32 are arranged in the plane P which also defines the orientation of the kelp seeded grow lines. It should be appreciated that with an octagonal shape, the arms 32 define eight different planes P, all which provide the diagonal orientation of the kelp seeded grow lines on the device 100. As discussed above, this unique orientation is substantially perpendicular to the sun rays 110, thus maximizing the sun exposure to the kelp seeded grow lines.

As mentioned above, the aquaculture device 100 may include a flotation structure 80 to adjust the buoyancy of the aquaculture device. In one embodiment, when the aquaculture device 100 is deployed in the ocean, the flotation structure 80 may fill with ocean water. In one embodiment, the flotation structure is torus shaped, and may for example, have an inverted donut style bell shape, and a portion of the flotation structure 80 (such as the bottom of the bell shape) may be open to permit the water to readily pass into the flotation structure 80 when the flotation structure 80 is submerged under water. As shown in FIGS. 1-2, in one embodiment, the aquaculture device 100 includes a hose 84 coupled to the flotation structure 80. The hose 84 may be selectively coupled to a compressor to fill the flotation structure 80 with air to increase the buoyancy of the aquaculture 100 to raise the device 100 up to the water surface 102 for either seeding, tending, maintenance, and/or harvesting the kelp. It should be appreciated that in one embodiment, the compressor (not shown) may be located on a boat. Once complete, the air hose 84 may be disconnected from the compressor and the flotation structure 80 may fill again with water to lower it back to its submerged position.

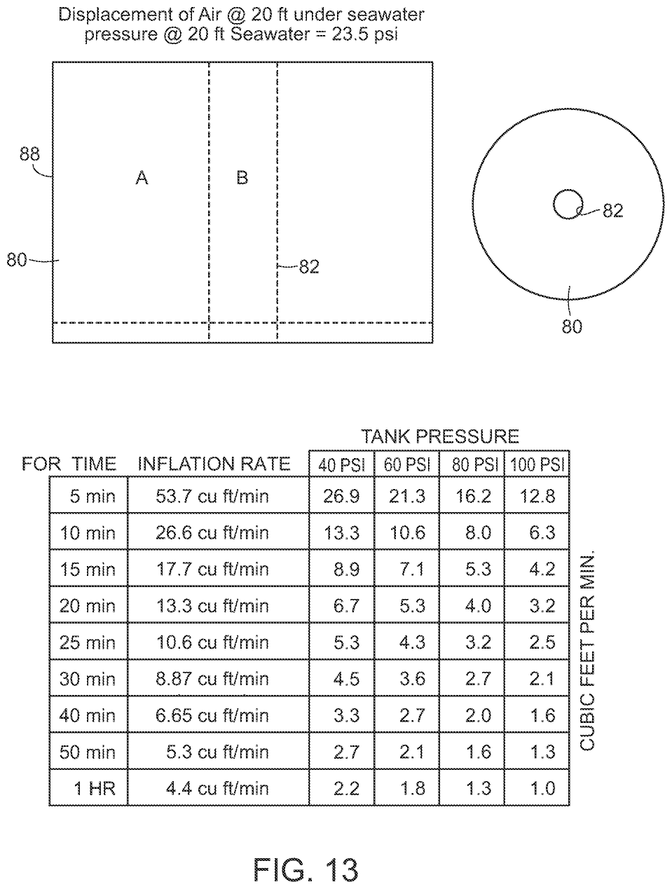

As shown in FIGS. 1-2, in one embodiment, the aquaculture device 100 further includes a mooring line 86 extending downwardly from the mooring ball 90, through the inner rims 24, 64 of the upper hub 20 and lower hub 60 (shown in FIGS. 4 and 6 respectively), and may also extends through the central hole 82 in the flotation structure 80. As shown, the hose 84 may be wrapped around the mooring line 86. As discussed above, in one embodiment, the flotation structure is at least partially open at the bottom so that when the aquaculture device 100 is submerged under water, the flotation structure 80 fills with water. It should be appreciated that the flotation structure 80 may include one or more walls 88 (see FIG. 13). The one or more walls 88 may be made or a flexible or rigid material. In one embodiment, the flotation structure 80 is configured as a bladder which may be defined generally to include anything inflatable and hollow and/or also as a receptacle for containing a liquid/or a gas.

As set forth in further detail below, the specific configuration and dimensions of the aquaculture device 100 may vary based upon the desired angle θ (i.e. desired diagonal orientation of the kelp seeded grow lines on the aquaculture device 100). Applicant recognized that by adjusting the length of the connecting arms 30 and/or 32, one can adjust the angle θ. Thus, in one embodiment, the plurality of connecting arms 30, and/or 32 are adjustable length so that the end user can modify the length based upon the specific deployment location and the angle of incidence of the sun. For example, in one embodiment, the connecting arms 30 and/or 32 are telescoping components to adjust to a range of desired lengths and corresponding angles θ. One of ordinary skill in the art will appreciate that increasing the length of the connecting arms 30 and/or 32 will make the angle θ increase when the outer rim 22 of the upper hub 20 and the outer rim 62 of the lower hub are held constant, whereas decreasing the length of the connecting arms 30 and/or 32 will decrease the angle θ.

As mentioned above, in one particular embodiment, the outer rim 22 of the upper hub 20 has a first perimeter of approximately 28 feet, and the outer rim 62 of the lower hub 60 has a second perimeter of approximately 72 feet. In one embodiment, the second perimeter is at least two times larger than the first perimeter, and in one particular embodiment, the second perimeter is at least approximately 2.5 larger than the first perimeter. The outer rim 22 of the upper hub 20 may be made of eight linear tubular segments which are approximately 3.5 feet in length. The outer rim 62 of the outer rim 62 may be made of eight linear tubular segments which are approximately nine feet in length.

In one embodiment, the outer rim 22 of the upper hub 20 may have a diameter of approximately 8 feet. and the outer rim 62 of the lower hub 60 may have a diameter of approximately 26 feet. In one embodiment, the vertical connecting arms 30 are approximately eight feet in length, and there may be eight connecting arms 30 spaced apart connecting the upper hub 20 to the lower hub 60.

In one embodiment, the inner rim 24 of the upper hub 20 may have a diameter of approximately one foot. The inner rim 24 may be made of eight linear tubular segments which are approximately 4.8 inches in length. Similarly, the inner rim 64 of the lower hub 60 may have a diameter of approximately one foot. The inner rim 64 may be made of eight linear tubular segments which are approximately 4.8 inches in length.

As mentioned above, in one embodiment, the lower hub 60 includes an intermediate rim 66 which has a third perimeter of approximately 28 feet. As shown in the figures, in one embodiment, the intermediate rim 66 has a third perimeter which is substantially equal to the first perimeter (i.e. perimeter of the outer rim 22 of the upper hub 20).

As discussed above, the upper hub 20 and/or the lower hub 60 may have a plurality of spokes 28, 68 which extend radially outwardly to the outer rims 22, 62. In one embodiment, the spokes may extend substantially the length of the diameter of the upper hub 20 and/or the lower hub 60. In another embodiment as shown in FIGS. 4-7, the plurality of spokes 28, 68 may extend from the inner rims 24, 64 of the upper and lower hubs 20, 60 outwardly to the respective outer rims 22, 62. Thus, in one embodiment, the spokes 28 on the upper hub 20 may extend approximately 3.5 feet in length between the inner rim 24 and the outer rim 22, and the spokes 68 on the lower hub 60 may extend approximately 12 feet in length between the inner rim 64 and the outer rim 66. It should be appreciated that in one embodiment, where the lower hub 60 also includes an intermediate rim 66, the spokes 68 on the lower hub may extend approximately four feet in length between the inner rim 64 and the intermediate rim 66, and another eight feet in length between the intermediate rim 66 and the outer rim 62.

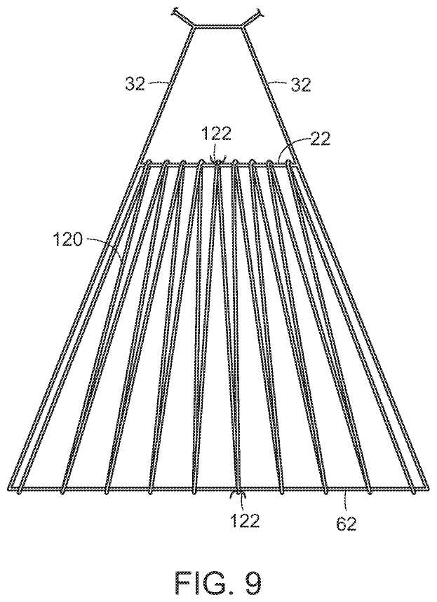

FIG. 9 illustrates one approach for securing the kelp seeded grow lines 120 to the upper hub outer rim 22 and the lower hub outer rim 62. As shown, the kelp seeded grow lines 120 may extend in a zigzag arrangement from the upper hub outer rim 22 to the lower hub outer rim 62. As shown in FIG. 9, in one embodiment, the aquaculture device 100 includes a plurality of hooks 122 which may be positioned on the upper hub outer rim 22 and the lower hub outer rim 62 and as shown, the plurality of hooks 122 are configured to hold the kelp seeded grow lines 122. It should be appreciated that hooks (i.e. clips or other fastening devices) may be secured to the upper hub 20, the lower hub 60 and/or the connecting arms 32 to attach and evenly space the kelp seeded grow lines to the aquaculture device 100.

The present disclosure also contemplates methods of growing kelp in the ocean. The method may include providing an aquaculture device 100 which includes an upper hub 20 having an outer rim 22, where the outer rim of the upper hub has a first perimeter, and a lower hub 60 having an outer rim 62, where the outer rim of the lower hub has a second perimeter, where the second perimeter is larger than the first perimeter. The device may also include a plurality of connecting arms 30, 32 coupling the upper hub to the lower hub. The method also includes placing the aquaculture device 100 in the ocean, and attaching kelp seeded grow lines 120 (see FIG. 9) to the outer rim 22 of the upper hub and to the outer rim 62 of the lower hub in a diagonal orientation.

The aquaculture device 100 may further includes a floatation structure 80 coupled to the lower hub 60, where the floatation structure 80 is configured to be filled with a fluid to adjust the buoyancy of the aquaculture device 100. The method of growing kelp in the ocean may further include coupling the floatation structure 80 to a compressor (which may for example be onboard a boat) and filling the floatation structure 80 with air to increase the buoyancy of the aquaculture device 100 and raise the aquaculture device up in the ocean.

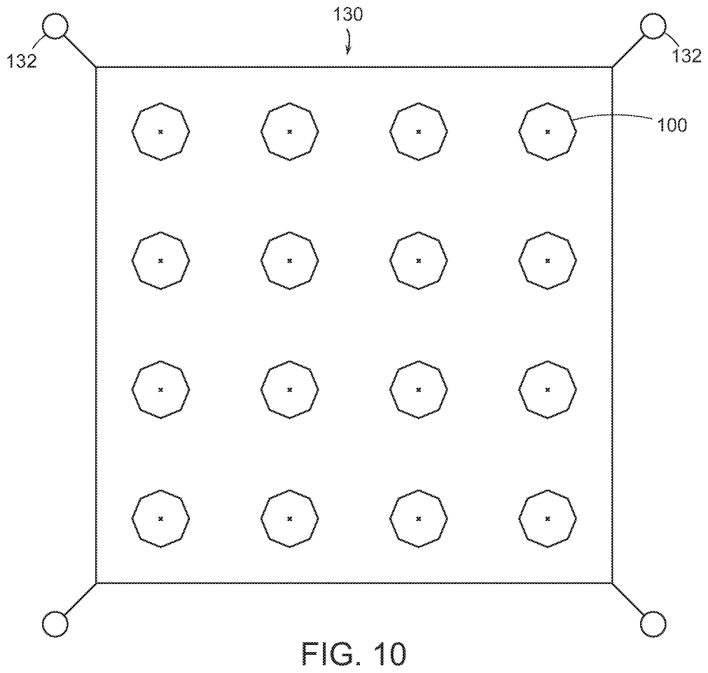

As shown in FIG. 10, in one embodiment, a plurality of aquaculture devices 100 are arranged in an array 130. The array 130 of aquaculture devices 100 may be arranged in rows and columns within a leased space in the ocean. In one embodiment, the leased ocean space is approximately one acre and may be defined by lease boundary buoys 132 in each corner.

Applicant recognized that each aquaculture device 100 may swing or move when deployed in the ocean due to ocean conditions, thus adequate spacing between the devices 100 may be important. For example, tide, wind, current and storm direction will move the device 100 around its single anchor 94. This requires the spacing of multiple devices 100 to be planned out prior to placement. The circle of travel for each device 100 will increase with greater depth. Shallow waters allow for more devices 100 and grow lines per acre than deeper sites. This placement allows the kelp farmer to maximize the number of devices within an acre boundary but not requiring additional acreage to accommodate an anchoring system. The single anchoring system of the device allows placement and swing to be within the lease acreage boundary.

In the particular embodiment illustrated in FIG. 10, the leased spaces is approximately 200 feet long and 200 feet wide (approximately one acre) and the 16 aquaculture devices 100 are spaced apart in four rows and four columns such that each aquaculture device 100 is within a space which is about 50 feet long and 50 feet wide. This array 130 configuration and spacing may be desirable for ocean depths up to approximately 50 feet deep. Applicant further recognized that due to ocean conditions such as tides and current, that when the array 130 is in ocean depths between approximately 50-100 feet, it may be desirable to space the aquaculture devices 100 farther apart. For example, in one embodiment when in ocean depths up to approximately 100 feet, the array 130 may include nine aquaculture devices 100 that are spaced apart in three rows and three columns in the same one acre ocean space.

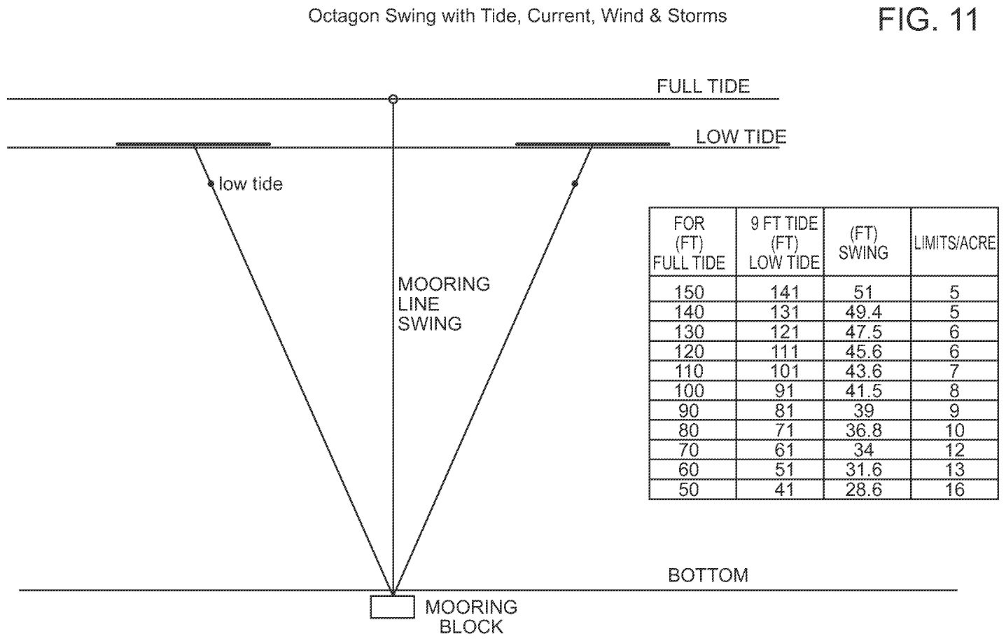

FIG. 11 is a schematic representation of the approximate amount of swing/movement of an aquaculture device 100 in the ocean based upon varying ocean conditions such as tide, current, wind and storms. As shown in the chart in FIG. 11, at an ocean depth of approximately 50 feet, the desired number of aquaculture devices 100 in the array 130 is about 16 per acre, which is depicted in FIG. 10. As also shown in the chart, at an ocean depth of approximately 90-100 feet, the desired number of aquaculture devices 100 in the array 130 is about 9-10 per acre, and finally, at an ocean depth of approximately 120-150 feet, the desired number of aquaculture devices 100 in the array 130 is about 5-6 per acre.

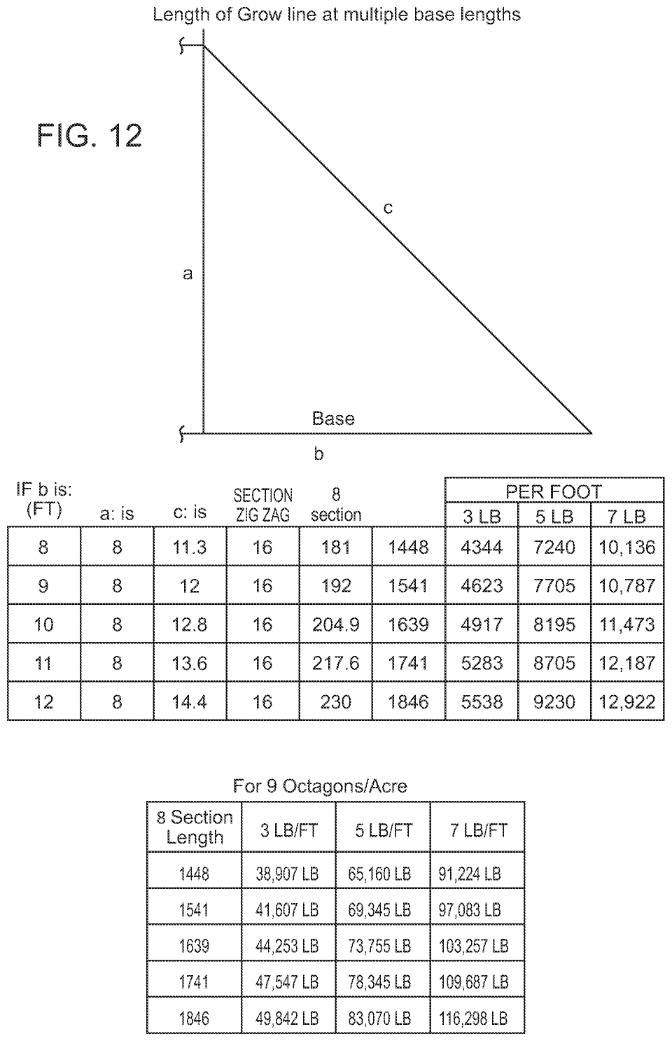

FIG. 12 is a schematic representation of the length of the seeded grow lines based upon different sized aquaculture devices 100 according to different embodiments of the present disclosure. In the schematic, line segment “c” may be defined as the length of the diagonal connecting arms 32 which couple the upper hub 20 to the lower hub 60. The upper point of line segment “c” is a point along the outer rim 22 of the upper hub 20, and the lower point of line segment “c” is a point along the outer rim 62 of the lower hub 60. Thus, line segment “c” defines the diagonal orientation and also the length of the kelp seeded grow lines. In the schematic, line segment “a” may be defined as the length of the vertical connecting arms 30 which couple the upper hub 20 to the lower hub 60. One can appreciate that the upper point of line segment “a” is a point near the outer rim 22 of the upper hub 20, and the lower point of line segment “a” may be a point near the intermediate rim 66 of the lower hub 60. Line segment “b” may be the radial length between the bottom of the vertical connecting arms 30 and the outer rim 62 of the lower hub 60.

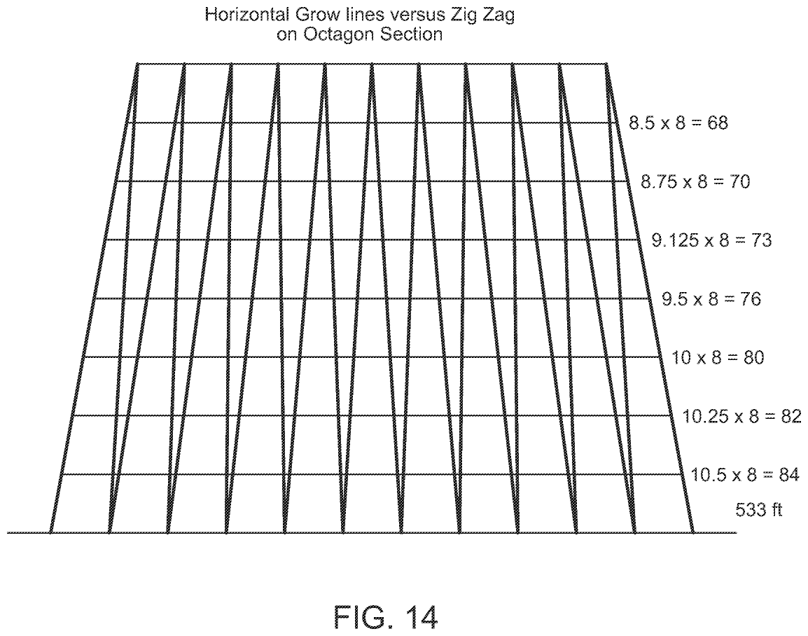

As shown in the chart in FIG. 12, if “a” is 8 feet and “b” is 8 feet, then “c” is 11.3 feet. If there are 16 zig zag sections of the seeded grow lines along the diagonal line segment “c” then the seeded grow line length in that segment is 181 feet of seeded grow lines. If that pattern is repeated for each of the eight segments of the octagon structure, then the seeded grow line length is 1,448 feet on one aquaculture device 100. For example, FIG. 14 illustrates a zig zag arrangement of the kelp seeded grow lines. As shown in FIG. 12, if there is approximately 3 pounds of kelp grown per foot of seeded grow line, that results in 4344 pounds of kelp harvested per aquaculture device 100. As shown in FIG. 12, if there is an array 130 of nine devices 100, that increases the total harvest to approximately 39,000 pounds of kelp harvested from a one acre site. FIG. 12 further illustrates the increasing amount of kelp that can be harvested by varying the dimensions of the aquaculture device 100.

As mentioned above, the flotation structure 80 may be coupled to a compressor to adjust the buoyancy of the aquaculture device 100. FIG. 13 is a schematic representation of the floatation structure 80 which illustrates compressor data according to one particular embodiment. As mentioned above, the flotation structure 80 may have an outer wall 88 and a central hole 82. The volume of the central hole 82 may be defined as volume B, such that the volume of the flotation structure 80 may be calculated as volume A-volume B. In one particular embodiment, the total diameter of the flotation structure 80 is approximately eight feet, the inner diameter of the central hole is approximately 1.5 feet, and the height of the outer wall 88 is approximately 5.5 feet, and therefore the volume of the flotation structure is about 266 cubic feet. The seawater pressure at about 20 feet water depth is about 23.5 psi. Thus, to displace seawater from the flotation structure 80 when the flotation structure 80 is about 20 feet under the water surface, the air compressor must be capable of pushing air at a pressure greater than 24 psi to inflate the flotation structure 80 with air and displace the water from the flotation structure 80. The chart in FIG. 13 illustrates compressor data for this particular flotation structure volume, and illustrates how the inflation time will vary based upon the compressor tank pressure.

As mentioned above, FIG. 14 is a schematic representation of zig-zag seeded grow lines on the aquaculture device according to one embodiment. FIG. 14 illustrates 20 zig zag seeded grow lines within one of the octagonal segments of the aquaculture device 100. When each zig zag segment is approximately 8 feet long (i.e. line segment “c” in FIG. 12), then with 20 zig zag segments that is approximately 1280 feet of seeded grow line per device for all eight octagonal segments. By contrast, as shown in FIG. 14, horizontal grow lines at seven spaced apart locations would only yield about 533 feet of seeded grow line per device. Thus, in one embodiment, the aquaculture device 100 of the present disclosure yields about 2.4 times of kelp seeded grow line in comparison to a horizontal configuration.

As set forth above, the present disclosure is directed to an aquaculture device 100 that is designed to make use of both the vertical and horizontal plane to maximize sun exposure and grow line length. Furthermore, the device 100 may be configured to take full advantage of light penetration zone for kelp growth in the 0-20 feet ocean depth. The device 100 may be designed for vertical anchoring with a single point. As set forth above, the design of the device 100 with the vertical anchoring may allow multiple devices 100 to be configured in an array within an acre lease boundary. Also, the flotation structure 80 allows the seeding, tending and harvesting to all occur at the water surface level without a need for a crane. Finally, the device 100 provides a greater length of grow lines per a lease boundary than the alternatives.

It should be appreciated that a variety of materials may be used to manufacture the above described aquaculture device. Various materials include, but are not limited to, fiberglass, stainless steel, and coated aluminum. The various diameters of rope and different sized buoys may be selected based upon the overall size and configuration of the device 100.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

1. An aquaculture device for growing kelp in the ocean, the device comprising:
an upper hub having an outer rim, wherein the outer rim of the upper hub has a first perimeter;
a lower hub having an outer rim, wherein the outer rim of the lower hub has a second perimeter, wherein the second perimeter is larger than the first perimeter;
a plurality of connecting arms coupling the upper hub to the lower hub;
wherein the upper hub and the lower hub are configured to hold kelp seeded grow lines in a diagonal orientation relative to the upper hub outer rim and the lower hub outer rim; and
a floatation structure coupled to the lower hub, wherein the floatation structure is configured to be filled with a fluid to adjust the buoyancy of the aquaculture device.

2. The aquaculture device of claim 1, wherein the upper hub outer rim and the lower hub outer rim each have a substantially octagonal shape.

3. The aquaculture device of claim 1, wherein the second perimeter is at least two times larger than the first perimeter.

4. The aquaculture device of claim 1, wherein the upper hub and the lower hub are configured to hold kelp seeded grow lines in a diagonal orientation between approximately 30° and approximately 60° relative to the upper hub outer rim and the lower hub outer rim.

5. The aquaculture device of claim 1, wherein the lower hub further comprises an intermediate rim, wherein the intermediate rim of the lower hub has a third perimeter, wherein the third perimeter is substantially equal to the first perimeter of the upper hub.

6. The aquaculture device of claim 5, wherein the plurality of connecting arms include a plurality of arms which extend in a substantially vertical orientation between the upper hub outer rim and the lower hub intermediate rim.

7. The aquaculture device of claim 1, wherein the plurality of connecting arms which extend in a diagonal orientation relative to the upper hub outer rim and the lower hub outer rim.

8. The aquaculture device of claim 1, wherein the upper hub further comprises an inner rim and a plurality of spokes extending radially outwardly from the inner rim to the outer rim of the upper hub.

9. The aquaculture device of claim 1, wherein the lower hub further comprises an inner rim and a plurality of spokes extending radially outwardly from the inner rim to the outer rim of the lower hub.

10. The aquaculture device of claim 1, further comprising a hose coupled to the floatation structure, wherein the hose is configured to selectively be coupled to a compressor to fill the floatation structure with air to increase the buoyancy of the aquaculture device.

11. The aquaculture device of claim 1, further comprising a mooring ball coupled to the upper hub.

12. The aquaculture device of claim 11, further comprising a plurality of suspension lines coupling the mooring ball to the upper hub.

13. The aquaculture device of claim 11, further comprising a mooring line and an anchor coupled to the mooring ball.

14. The aquaculture device of claim 13, wherein the floatation structure is torus shaped having a hole extending therethrough, wherein the mooring line extends through the hole in the floatation structure.

15. The aquaculture device of claim 1, further comprising a plurality of hooks on the upper hub outer rim and the lower hub outer rim, wherein the plurality of hooks are configured to hold kelp seeded grow lines.

16. The aquaculture device of claim 1, further comprising a plurality of kelp seeded grow lines extending in a diagonal orientation, wherein the plurality of kelp seeded grow lines extend in a zigzag arrangement from the upper hub outer rim to the lower hub outer rim.

17. A method of growing kelp in the ocean, the method comprising:
providing an aquaculture device, the aquaculture device comprising:
an upper hub having an outer rim, wherein the outer rim of the upper hub has a first perimeter;
a lower hub having an outer rim, wherein the outer rim of the lower hub has a second perimeter, wherein the second perimeter is larger than the first perimeter; and
a plurality of connecting arms coupling the upper hub to the lower hub;
placing the aquaculture device in the ocean; and
attaching kelp seeded grow lines to the outer rim of the upper hub and to the outer rim of the lower hub in a diagonal orientation.

18. The method of claim 17, wherein the aquaculture device further includes a floatation structure coupled to the lower hub, wherein the floatation structure is configured to be filled with a fluid to adjust the buoyancy of the aquaculture device, the method further comprising:
coupling the floatation structure to a compressor; and
filling the floatation structure with air to increase the buoyancy of the aquaculture device and raise the aquaculture device up in the ocean.
